(19) United States
(12) Patent Application Publication
(10) Pub. No.: US 2009/0229479 A1
(43) Pub. Date: Sep. 17, 2009

(54) Dip and drain canister colander

(76) Inventor: Dorothy Jean Nelson, Country Club Hills, IL (US)

Correspondence Address: Dorothy Jean Nelson, 4250 West 188th Street, Country Club Hills, IL, 60478, US

(21) Appl. No.: 12/313,040

(22) Filed: Nov. 18, 2008

Related U.S. Application Data
(60) Provisional application No. 61/069,145, filed on Mar. 13, 2008.

(51) Int. Cl. A47J 43/24; A47J 19/00

(52) U.S. Cl. 99/495; 210/407

(57) ABSTRACT

Colanders are perforated utensil, basically used for draining foods. The Dip and Drain Canister Colander is used for washing and draining vegetables and fruits fresh or frozen. It has a rectangular shape with medium holes throughout the entire colander, that allows water to flow inside and outward when dipping and draining. The canister colander has a clamp on lid to confine vegetables and fruits as needed when washing vegetables and fruits. The lid clamps inside the top of the canister colander. The rectangular shaped canister colander is a four sided figure, with opposite sides, that are parallel and equal. It also has a pull device which is a handle that is attached to the upper back section of the canister colander, to hold with hand when maneuvering. The canister colander can be maneuvered in several ways. Using the lid is very crucial to get a thorough washing, when carrying out the different kinds of maneuvers. In figure number five, gives an over-all description of the view of the photograph of the Dip and Drain Canister Colander that is made of perforated stainless steel heavy duty wire, with medium holes throughout the entire colander, with white plastic trim. Using my mind, hands, and tools such as plier, screw driver, wire cutter, and a ruler, the Dip and Drain Canister Colander was made by Dorothy Jean Nelson as stated in the Specification on page one. The Dip and Drain Canister is revolutionary, because of the way it is made, and its cleansing process, for washing vegetables and fruits.

### BACKGROUND OF INVENTION

After washing Romaine Lettuce in my kitchen sink filled with water to remove debris such as dirt, sand, insect particles and pesticide, the leaves would fall apart from the stalk. I realized there must be a better way to wash Romaine Lettuce, and get a good result. The original Bowl shaped colander is not structured for washing Romaine Lettuce thoroughly. It is round at the top and narrow at the base. A special made colander would have to be invented to accommodate washing Romaine Lettuce, which grows upright with volume and length. This is why I invented the Dip and Drain Canister Colander. It is made of perforated stainless steel heavy duty wire, with medium holes throughout the entire colander, which allows water to flow freely inside and outward. Unlike other colanders, it is a canister with a rectangular shape, a four sided figure with opposite sides that are parallel and equal. There is white plastic trim on all four corners, also on the left and right sides at the bottom base, at the opening area of the canister colander there is white trim on all four sides. It has a clamp on lid, made of perforated stainless steel heavy duty wire, approximately six inches on all four sides with white plastic trim, with a flat surface on both sides. The stability of the Dip and Drain Canister Colander is supported by braces, washers, notch headed screws and hex nuts. The depth of the canister colander is approximately eleven inches. It holds approximately five quarts in quantity. The silver pull which is the handle, is attached to a white plastic base on the upper back of the canister colander. The canister colander is maneuvered by holding the pull. There are several ways to maneuver, front face down which is length-wise, in water, rotating from side to side, swaying from side to side, then lift and drain or hold the canister colander upright dip and drain which is done repeatedly. The lid should always be used to confine vegetables and fruits, fresh or frozen when washing because it is very crucial in getting a thorough washing, when carrying out the different kinds of maneuvers. The Dip and Drain Canister Colander is a great invention for washing fresh green leaf vegetables such as Spinach, Turnips, and Mustard greens. Last but not least I have often thought, how clean are the frozen vegetables and fruits that are purchased in the stores? If you want to know my answer try the Dip and Drain Canister Colander and it will reveal the answer to you. The Dip and Drain Canister Colander is revolutionary, because of the way it is made, and its cleansing process, for washing vegetables and fruits. Using my mind, hands, pliers, screw driver, wire cutter, and a ruler the Dip and Drain Canister Colander was made by Dorothy Jean Nelson.

### BRIEF SUMMARY OF THE INVENTION

The rectangular shaped canister colander can be maneuvered in several ways, front face down in water, rotating from side to side, swaying from side to side, back and forth, then lift and drain or hold the canister colander upright, dip and drain which is done repeatedly. This special made colander was invented to accommodate washing Romaine Lettuce, which grows upright with volume and length. The Dip and Drain Canister Colander is a great invention for washing fresh leaf vegetables such as Spinach, Turnips, and Mustard greens. The uses of the lid to confine fruits and vegetables fresh or frozen is very crucial to get a thorough washing, you must use the lid with the above maneuverers. Last but not least, I have often thought, how clean are the frozen vegetables and fruits that are purchased in the stores. If you want to know my answer, try the Dip and Drain Canister Colander and it will reveal the answer to you. The Dip and Drain Canister Colander is revolutionary, because of the way it is made, and its thorough cleansing process, for washing vegetables and fruits. Using my mind, hands, pliers, screw driver, wire cutter, and a ruler the Dip and Drain Canister Colander was made by Dorothy Jean Nelson.

### BRIEF DESCRIPTION OF THE SEVERAL VIEWS OF THE PHOTOGRAPH

FIG. 1. View of the Dip and Drain Canister Colander showing the top opening area and the inside structure.

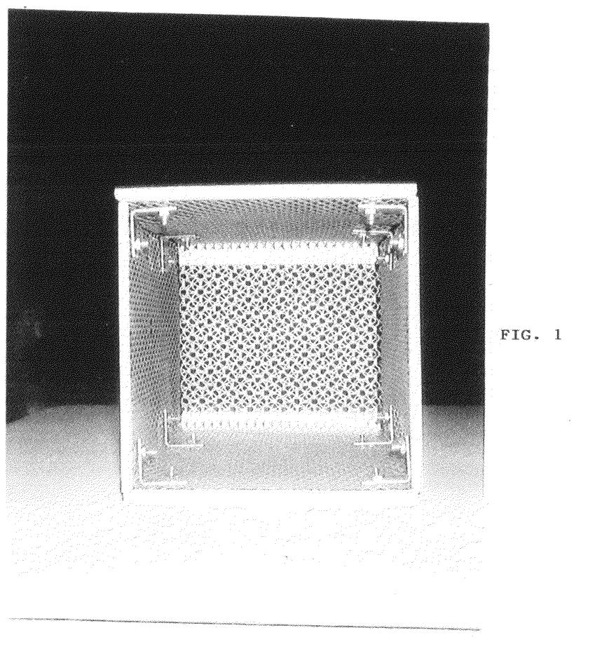

FIG. 2. View of the Dip and Drain Canister Colander, upright showing white plastic trim on the top, sides and corners.

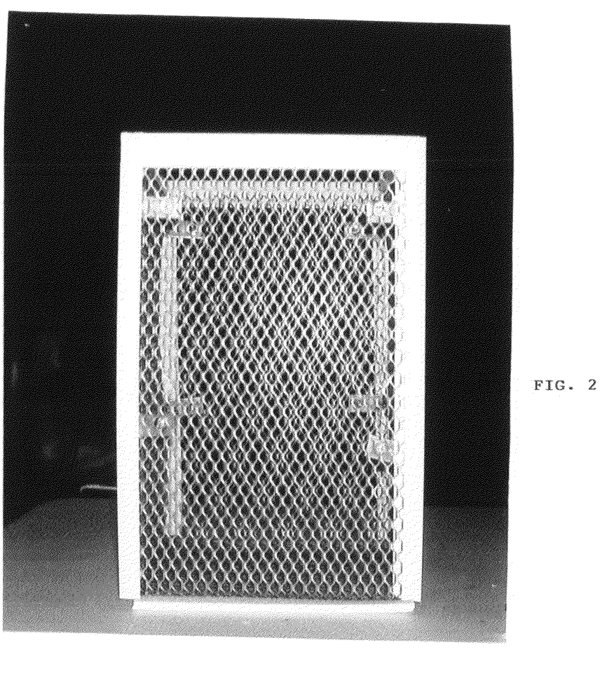

FIG. 3. View of the Dip and Drain Canister Colander, showing the pull, which is the handle that is attached to the upper back.

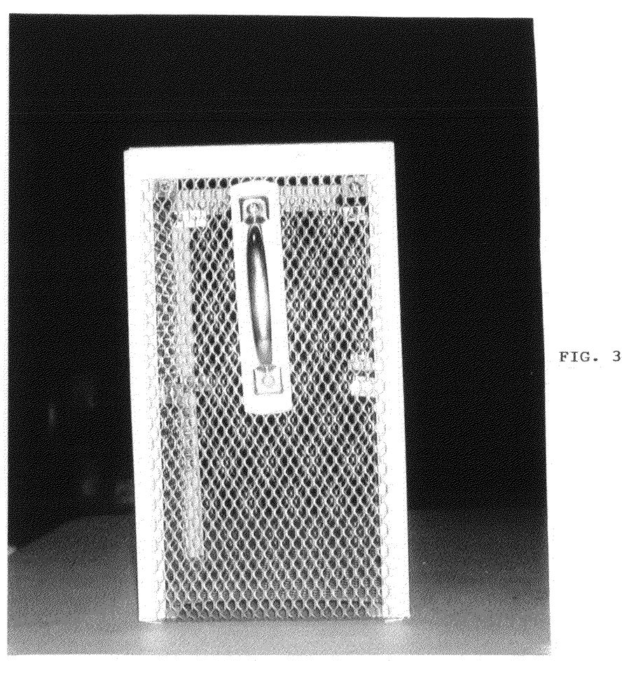

FIG. 4. View of the Dip and Drain Canister Colander showing the lid clamped inside the top of canister colander, that confine the vegetables and fruits.

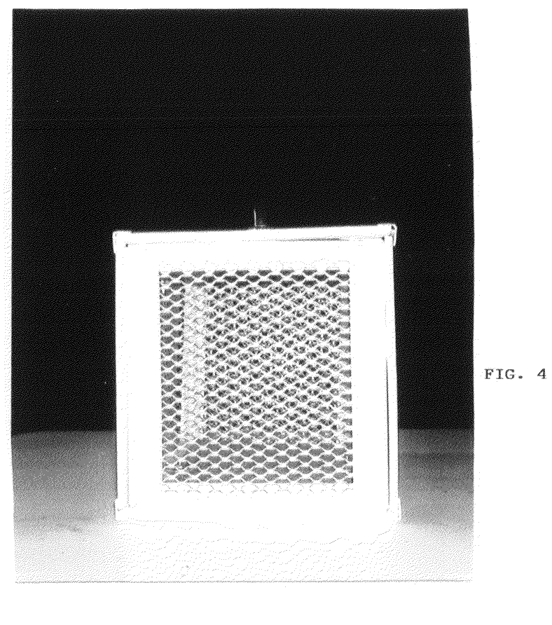

FIG. 5. View of the Dip and Drain Canister Colander, showing the over-all finished product.

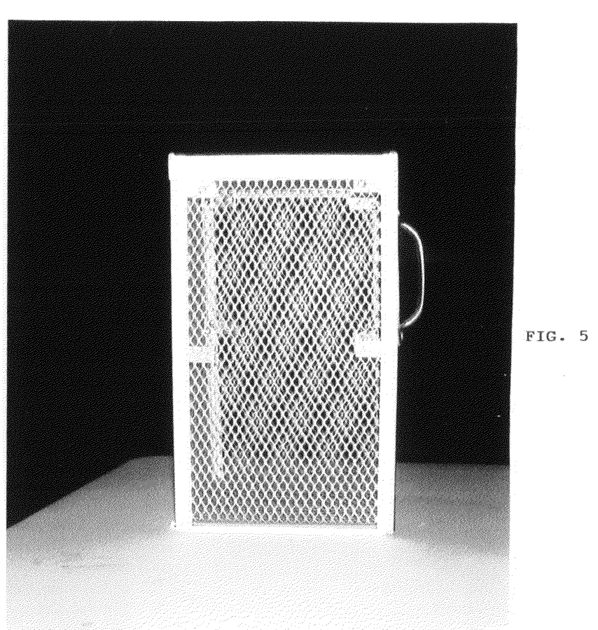

### DETAILED DESCRIPTION OF THE INVENTION

Two pieces of measured perforated stainless steel heavy duty wire, is bent with a base that is approximated six inches, on all four sides, with extended upright sides parallel to each other. The two pieces of stainless steel perforated wire are joined together criss-cross base to base forming a rectangular shape. It has four upright sides that are parallel and equal. The four upright sides are connected together using corner braces, notch headed screws, washers, and hex nuts as shown in the Brief Description of views of The Photographs, in figure number one. White plastic border strips and corner strips are used to secure the raw edges and give stability to the Dip and Drain Canister Colander as illustrated in figure number two. The lid is made with a square piece of perforated stainless steel heavy duty wire, which is approximately six inches on all four sides. White plastic border strips on all four sides, with two parallel reversed on opposite sides. The strips are latched between the ridges to secure the raw edges and give stability to the lid. The lid has a flat surface on both sides, it is removable. The lid clamps inside the top of the canister colander. The extension of the screws at the top inside of the canister colander shown in figure number one restricts the lid from moving beyond. Figure number four shows a photograph of the lid attached to the canister colander. Figure number five is an over-all description of view of the Dip and Drain Canister Colander. Using my mind, hands, pliers, screw driver, wire cutter, and a ruler, the Dip and Drain Canister Colander was made by Dorothy Jean Nelson.

1. What I claim as my invention is that my Dip and Drain Canister Colander has a rectangular shape, with a four sided figure, the opposite sides are parallel and equal with a depth of eleven inches.

2. What I claim as my invention is that my Dip and Drain Canister Colander has a pull which is a handle on the upper back of the canister colander. The pull is to hold when maneuvering the canister colander.
